(19) United States
(12) Patent Application Publication
(10) Pub. No.: US 2015/0380224 A1
(43) Pub. Date: Dec. 31, 2015

(54) ELECTRONIC AMPLIFYING SUBSTRATE AND METHOD OF MANUFACTURING ELECTRONIC AMPLIFYING SUBSTRATE

(71) Applicant: HOYA CORPORATION, Shinjuku-ku, Tokyo (JP)

(72) Inventor: Takashi FUSHIE, Tokyo (JP)

(73) Assignee: HOYA CORPORATION, Tokyo (JP)

(21) Appl. No.: 14/769,003

(22) PCT Filed: Feb. 24, 2014
(86) PCT No.: PCT/JP2014/054284

§ 371 Date: Aug. 19, 2015

(30) Foreign Application Priority Data
Mar. 1, 2013 (JP) 2013-041016

(51) Int. Cl. H01J 43/08; H01J 9/12; H01J 47/02

(52) U.S. Cl. CPC H01J 43/08; H01J 47/026; H01J 9/125

(57) ABSTRACT

An electronic amplifying substrate, including: a glass base material having an insulating property; conductive layers formed on both main surfaces of the glass base material; and a plurality of through holes formed on a lamination body of the glass base material and the conductive layer, wherein an electric field is formed in the through hole by a potential difference between both conductive layers during application of a voltage to a surface of the conductive layer so that an electron avalanche amplification occurs in the through hole, and an insulation part is formed on at least one main surface of the glass base material, with one of the end portions of the insulation part formed to surround an opening part of the through hole of the glass base material, and the other end portion formed in contact with the end portions of the conductive layers.

### TECHNICAL FIELD

The present invention relates to an electronic amplifying substrate and a method of manufacturing an electronic amplifying substrate.

### DESCRIPTION OF RELATED ART

In recent years, as a detector for detecting a particle beam or an electromagnetic wave, there is known a technique of utilizing an electron avalanche amplification by a gas electronic amplifier (abbreviated as “GEM” hereafter).

A general GEM is provided with an electronic amplifying substrate with both surfaces of a plate-like member made of polyimide, etc., having insulating properties covered with an electrode layer made of coper, etc., having conductivity, and having a plurality of through holes formed thereon so as to pass through front and rear of a lamination body of the plate-like member and the electrode layer. Then, a strong electric field is created in a plurality of through holes by applying a potential difference between electrode layers of the electronic amplifying substrate in a state that the electronic amplifying substrate is disposed in a detection gas, and an electron avalanche amplification is caused by this electric field to increase the number of ionized electrons captured as a signal. Thus, the ionized electrons in the detection gas can be measured (for example, see patent document 1).

Incidentally, regarding GEM, when the electron avalanche amplification is caused, it is requested that high amplification factor (gain) can be obtained per one sheet of the electronic amplifying substrate. This is because if the high amplification factor can be obtained per one sheet, multiple stages of the electronic amplifying substrate is not required, and detection of neutron as an example of a particle beam, can be expected by improvement of a measurement capability.

In order to obtain the high amplification factor, it can be considered that a strong electric field is formed in the through hole, by increasing a voltage applied to each electrode layer in the electronic amplifying substrate, thereby increasing the potential difference between electrode layers. However, if the applied voltage is increased, discharge is likely to occur between the electrode layers (namely, in the through hole), and there is a problem that an electrical circuit, etc., for measuring (namely reading a signal of) the ionized electrons is broken due to the discharge.

Therefore, as shown in FIG. 7, for example, non-patent document 1 proposes that a guard part 53 is provided at each side of both surfaces of a plate-like member 52, for the purpose of suppressing a generation of discharge in a through hole 51. The guard ring part 53 is a planar ring-shaped gap groove formed along an outer circumference of an opening part of the through hole 51. A land part 55 exists on the circumferential edge of the opening part of the through hole 51 so as not to communicate with an electrode layer 54. In the electronic amplifying substrate with this structure that the guard ring part 53 and the land part 55 exist, when a voltage is applied to each electrode layer 54 disposed on both surfaces of the plate-like member 52, an electric field is formed between land parts 55 (namely in the through hole 51) disposed on both surfaces of the plate-like member 52, due to dielectric effect generated between the electrode layer 54 and the land part 55. However, voltage drop occurs between the electrode layer 54 and the land part 55, because the guard ring part 53 works as an electric resistance. Accordingly, the voltage drop occurs in the electrode layer 54 in the vicinity of the circumferential edge of the through hole 51 even if the same voltage is applied to the electrode layer 54, compared with a case that the guard ring part 53 and the land part 55 don't exist, and therefore the discharge hardly occurs in the through hole 51.

### PRIOR ART DOCUMENT

### Patent Document

Patent document 1: Japanese Patent Laid Open Publication No. 2006-302844

### Non-Patent Document

Non-patent document 1: “Development of GlassGEM detector”, by Yuki Mitsuya, Isotope News March, 2011 (pp 16-18, 2010 IEEE Nuclear Science Symposium, October 30-November 5, N66-5, Knoxville, USA

### SUMMARY OF THE INVENTION

### Problem to be Solved by the Invention

However, the electronic amplifying substrate having a structure in which the guard ring part 53 is provided on both surfaces of the plate-like member 52, involves a problem as follows.

In the abovementioned structure, the voltage drop occurs on both surfaces of the plate-like member 52 respectively, and therefore a strong electric field cannot be formed between land parts 55 on the both surfaces (namely, in the through hole 51) even if the same voltage is applied thereto, compared with a case that the guard ring part 53 and the land part 55 don't exist. In order to avoid such a situation, high voltage can be probably applied in consideration of the voltage drop. However, in this case, there is a risk of generating the discharge between the electrode layer 54 and the land part 55 with the guard ring part 53 sandwiched between them, because a groove width of the guard ring part 53 is extremely smaller than a plate thickness of the plate-like member 52.

Namely, in the above-described structure, it would be difficult to form a strong electric field in the through hole 51, and a sufficient gain cannot be obtained in the electron avalanche amplification. On the other hand, if the strong electric field is attempted to be formed in the through hole 51, the discharge possibly occurs at a portion other than the through hole 51.

Therefore, an object of the present invention is to provide an electronic amplifying substrate and a method of manufacturing the same, capable of obtaining a sufficient gain at the time of electron avalanche amplification, while suppressing the generation of the discharge leading to a destruction of an electric circuit, etc., for reading a signal, without reducing an application voltage in an electrode layer in the vicinity of the through hole (in the vicinity of an end portion of the electrode layer).

### Means for Solving the Problem

In order to achieve the above-described object, according to an aspect of the present invention, there is provided an electronic amplifying substrate, including:

a glass base material having an insulating property;

conductive layers formed on both main surfaces of the glass base material; and

a plurality of through holes formed on a lamination body of the glass base material and the conductive layer,

wherein an electric field is formed in the through hole by a potential difference between both conductive layers during application of a voltage to a surface of the conductive layer so that an electron avalanche amplification occurs in the through hole, and

an insulation part is formed on at least one main surface of the glass base material, with one of the end portions of the insulation part formed to surround an opening part of the through hole of the glass base material, and the other end portion formed in contact with the end portions of the conductive layers.

According to another aspect of the present invention, there is provided a method of manufacturing an electronic amplifying substrate including:

a glass base material having an insulating property;

conductive layers formed on both main surfaces of the glass base material; and

a plurality of through holes formed on a lamination body of the glass base material and the conductive layer,

wherein an electron avalanche amplification occurs in the through hole by forming an electric field in the through hole by a potential difference between both conductive layers when a voltage is applied to a surface of the conductive layer,

the method comprising:

making an end portion of the conductive layer formed on at least one main surface of the glass base material retreat from an opening part of the through hole of the glass base material, by applying processing to the formed conductive layers using a laser beam.

### Advantage of the Invention

According to the present invention, a sufficient gain can be obtained at the time of electron avalanche amplification, while suppressing generation of a discharge leading to a destruction of an electric circuit, etc., for reading a signal, without reducing a voltage applied to an electrode layer.

### BRIEF DESCRIPTION OF THE DRAWINGS

FIG. 1 is an explanatory view showing a schematic constitutional example of a detector according to this embodiment.

FIG. 2 is an explanatory view showing a constitutional example of an essential part of an electronic amplifying substrate according to this embodiment, wherein (a) is a perspective view and (b) is a lateral cross-sectional view.

FIG. 3 is a view showing an example of the electronic amplifying substrate.

FIG. 4 is a view showing an example of a chamfering of a corner portion of a glass base material in the electronic amplifying substrate according to this embodiment.

FIG. 5 is an explanatory view (No. 1) showing an example of a method of manufacturing an electronic amplifying substrate according to this embodiment.

FIG. 6 is an explanatory view (No. 2) showing an example of a method of manufacturing an electronic amplifying substrate according to this embodiment.

FIG. 7 is a perspective view showing a constitutional example of an essential part of the electronic amplifying substrate according to a conventional example.

### DETAILED DESCRIPTION OF THE INVENTION

The present invention will be described in detail in the following order, based on an embodiment shown in the figure.

1. Schematic structure of a detector
2. Structure of an electronic amplifying substrate
3. Method of manufacturing an electronic amplifying substrate
4. Measurement procedure of ionized electrons in the detector
5. Effect of this embodiment
6. Modified example, etc.

### 1. Schematic Structure of a Detector

A schematic structure of a detector constituted using an electronic amplifying substrate of this embodiment, will be described first. The detector makes it possible to measure ionized electrons utilizing electron avalanche amplification in a detection gas, thus detecting a particle beam or an electromagnetic wave.

The “electron avalanche amplification” utilized by the detector is a phenomenon as follows: when free electrons collide with gas molecules in a strong electric field, new electrons are knocked out, which are then accelerated in the electric field to thereby further collide with another molecules, and increase of the number of electrons are further accelerated. The detector utilizing the electron avalanche amplification includes a capillary gas proportional counter (CGPC). However, in this embodiment, a device that causes the electron avalanche amplification using GEM is called the detector.

Here, the “GEM” is the detector configured to create the strong electric field in the through hole in the electronic amplifying substrate in a state that the electronic amplifying substrate having a plurality of fine through holes arranged two-dimensionally is disposed in the detection gas, and cause an electron avalanche amplification by this electric field. The electronic amplifying substrate may have a single plate-like shape or may be formed in a multilayered structure of a plurality of sheets.

The “particle beam” to be detected by the detector includes alpha rays, beta rays, proton beams, heavy charged particle rays, electron beams (which accelerates electrons in an accelerator regardless of a nuclear decay), neutron rays, and cosmic line, etc. Also, the “electromagnetic wave” includes radio waves (low frequency, very low frequency (VLF), long wave, medium wave, short wave, very high frequency (VHF), and microwave), lights (infrared, visible, ultraviolet), X-rays, and gamma rays, etc. Which one of these rays is selected to be detected, can be set as desired one by suitably selecting the kind of the detection gas or electric field strength, etc.

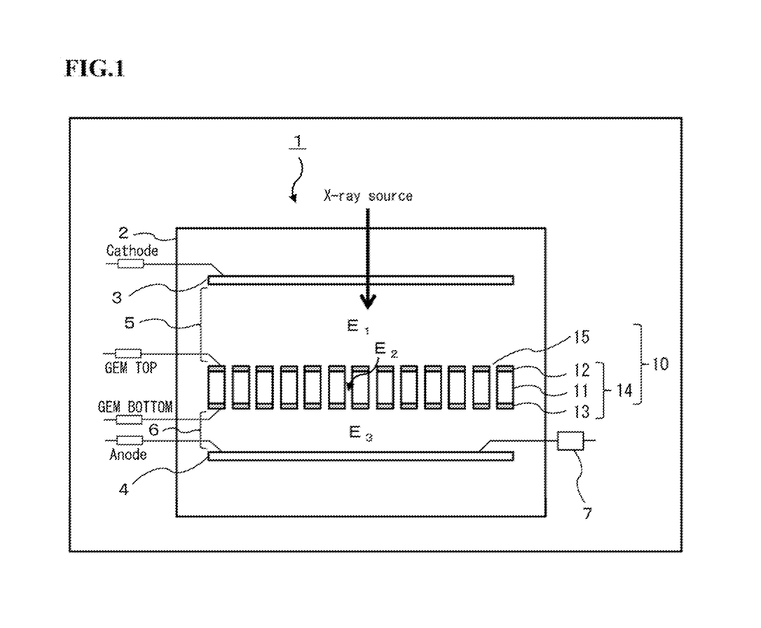

The abovementioned detector, namely the detector that performs detection of the particle beam or the electromagnetic wave utilizing the electron avalanche amplification by GEM, has a structure shown in FIG. 1.

A detector 1 shown in FIG. 1 includes a drift electrode 3 and a read electrode 4 in a chamber 2 filled with a specific kind of detection gas, and also includes an electronic amplifying substrate 10 disposed between the drift electrode 3 and the read electrode 4. The electronic amplifying substrate 10 realizes a function as GEM by causing the electron avalanche amplification, and is constituted by two-dimensionally arranging a plurality of through holes 15 on a lamination body 14 in which conductive layers 12 and 13 are formed on both main surfaces of the glass base material 11. The plurality of through holes 15 are arranged at constant intervals, with each of them having a circular shape when the electronic amplifying substrate 10 is viewed in plan view. The chamber 2 is configured so that the particle beam or the electromagnetic wave can be incident from outside so as to be detected.

A specific voltage is applied to the drift electrode 3 and the read electrode 4 in the chamber 2, from a power supply part not shown. Further, the specific voltage is also applied to the conductive layers 12 and 13 respectively on both main surfaces of the electronic amplifying substrate 10 from the power supply part not shown, so that each of them functions as an electrode. By the voltage application from such a power supply part, electric field E1 is generated in a region 5 (called a “drift region” hereafter) between the drift electrode 3 and the electronic amplifying substrate 10, and electric field E3 is generated in a region 6 (called an “induction region” hereafter) between the electronic amplifying substrate 10 and the read electrode 4. Also, electric field E2 is generated in the through hole 15 of the electronic amplifying substrate 10. Then, the electric field E2 is converged in the through hole 15, and the electrons invading into the electric field E2 is accelerated, to thereby cause the electron avalanche amplification, and the electrons multiplied by this electron avalanche amplification are measured by the read electrode 4.

Further, an application specific integrated circuit 7 (abbreviated as “ASIC” hereafter) having a function as a protection circuit, an amplifier circuit, and a noise filter circuit, etc., is connected to the read electrode 4. The ASIC 7 is the circuit for enabling a signal to output to an external device (for example, a higher-level device of the detector 1) regarding a measurement result obtained by the read electrode 4, and functions as an electric circuit for reading a signal. That is, the detector 1 is configured to measure the electrons by the read electrode 4, the electrons being multiplied by the electron avalanche amplification generated in the through hole 15 of the electronic amplifying substrate 10, and output the measurement result to outside through ASIC 7 connected to the read electrode 4.

### 2. Structure of the Electronic Amplifying Substrate

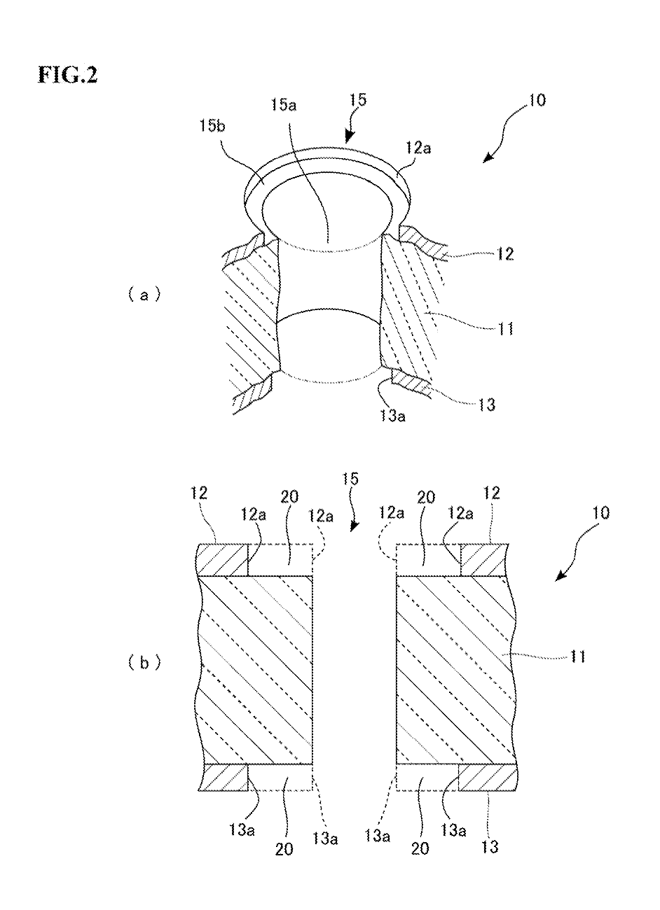

The structure of the electronic amplifying substrate 10 according to this embodiment, will be described next, suing FIG. 2.

The electronic amplifying substrate 10 has a structure in which a plurality of through holes 15 are two-dimensionally arranged on the lamination body 14 composed of conductive layers 12 and 13 on both main surfaces of the glass base material 11. FIG. 2 shows only one through hole. The electric field is formed in the through hole 15 so that the electron avalanche amplification occurs in the through hole 15 by making a potential difference between both conductive layers 12 and 13 by applying a voltage to each of the conductive layers 12 and 13.

The base material for constituting the electronic amplifying substrate 10 is required to have an insulating property. For example, a resin material such as polyimide is used as the base material for the general GEM. However, the resin material has a problem that outgas would be generated, due to low heat resistance, smoothness, and rigidity, etc. Accordingly, the glass base material 11 is used as a material having the insulating property. However, the glass base material 11 is formed by arranging the through holes 15 at fine pitches with each having a fine diameter, and therefore a finely-processable glass material is used. In this embodiment, a photosensitive glass is preferably used as the glass base material. By using the photosensitive glass, a fine processing technique used for a semiconductor manufacturing process, can be applied, to thereby form a plurality of through holes having a desired dimension and a desired arrangement pitch.

In this embodiment, a glass containing small quantities of Au, Ag, and Cu in SiO₂—Li₂O—Al₂O₃-based glass as photosensitive components, and further containing CeO₂ therein as sensitizers, is used as the “photosensitive glass”. By irradiating the photosensitive glass with ultraviolet rays, an oxidation reduction reaction occurs between the sensitizer and the photosensitive component, and metal atoms are generated. When the photosensitive glass is further heated in this state, the metal atoms are aggregated to form a colloid, and a crystal of Li₂O.SiO₂ (lithium metasilicate) is precipitated and grown, with the colloid as a crystal nuclei. Precipitated Li₂O.SiO₂ (lithium metasilicate) is easily dissolved in hydrogen fluoride (HF), and there is about 50 times of difference between a dissolution rate of HF and a dissolution rate of a glass portion not irradiated with ultraviolet rays. By utilizing such a difference of the dissolution rate, selective etching can be performed to apply etching only to a portion (crystal portion) irradiated with ultraviolet rays, and a fine processing can be performed without using a mechanical processing. For example “PEG3 (product name)” by HOYA Corporation can be given as such as photosensitive glass.

Further, the conductive layers 12 and 13 are respectively formed on both main surfaces of the glass base material 11 in the electronic amplifying substrate 10. The conductive layers 12 and 13 are made of a material having conductivity, and its surface layer has a role as an electrode layer. A metal material such as Cu (copper) for example, can be used as the material having conductivity. However, the conductive layers 12 and 13 are not necessarily required to have a single layer structure, and may have a multilayer structure if each layer is electrically connected to each other. For example, in order to improve adhesion to the glass base material 11, a layer made of Cr (chromium), etc., may be interposed between the glass base material 11 and the copper layer.

As shown in FIG. 2(a) and FIG. 2(b), in the electronic amplifying substrate 10 of this embodiment, end portions 12a and 13a of the conductive layers 12 and 13 are retreated from the opening part of the through hole 15, over the whole circumference of the through hole 15. In other words, the through hole 15 formed on the substrate 10 is composed of a through hole 15a formed on the glass base material 11, and two through holes 15b formed on the conductive layers 12 and 13. As clarified from FIG. 2(a) and FIG. 2(b), the diameter of the through hole 15b is larger than the diameter of the through hole 15a.

By having such a structure, the conductive layer does not exist between a flush position and a retreat position, and instead an insulation part 20 is formed, when compared with a case that the end portions 12a and 13a of the conductive layers 12 and 13, and the opening part of the through hole 15a of the glass base material 11 are flush with each other (a case that the diameter of the through hole 15b and the diameter of the through hole 15a are the same). That is, the opening part of the through hole 15a is surrounded by one of the end portions of the insulation part 20, and the other end portion of the insulation part 20 is brought into contact with the end portion of the conductive layer. In this embodiment, the insulation part 20 is formed by a space where the conductive layers 12 and 13 are not formed. In other words, an insulation effect is caused by a gas present in this space (such as a detection gas with which a chamber is filled). The insulation part 20 may also be made of resin, etc., having insulation property.

Electric force lines are easily concentrated at the end portion of the conductive layer, when the voltage is applied to the electronic amplifying substrate and the electric field is generated. Therefore, as shown by dot line in FIG. 2(b), when the end portion of the conductive layer is flush with the opening part of the through hole, discharge is likely to occur between conductive layers, namely between conductive layer 12 and conductive layer 13 formed on both main surfaces of the electronic amplifying substrate.

When such a discharge occurs between the conductive layers via the through hole, damage is added on the substrate, and the electron avalanche amplification does not occur or insufficient in the through hole. Further, there is a risk that ASIC 7 connected to the read electrode 4 is destructed. Therefore, when the discharge occurs, performance as the electronic amplifying substrate cannot be exhibited.

On the other hand, in this embodiment, due to existence of the insulation part 20, distance between the end portion 12a of the conductive layer 12 and the end portion 13a of the conductive layer 13 becomes large. Such a situation means that a virtual conductive line connecting the conductive layers 12 and 13 becomes long, and therefore the discharge between the conductive layers can be suppressed. In addition, not only the discharge distance is simply extended, but also a circumferential portion of the hole where the electric force lines are concentrated can be positioned distance away from the hole. Accordingly, it is conceivable to suppress the discharge only by a slight retreat of the end portion of the conductive layer from the opening part of the through hole. The end portions of the conductive layers 12 and 13 are retreated from the opening part of the through hole 15a, and a conductive part does not exist between the end portion and the opening part. Therefore, an application voltage is not reduced even in the vicinity of the end portion of the conductive layer.

Generally, when the end portions 12a and 13a of the conductive layers 12 and 13 are retreated, the number of the electric force lines are reduced in the through hole 15, and as a result, it is easily predicted that the gain in the through hole 15 is also reduced. Accordingly, a skilled person does not achieve the structure such that the end portions 12a and 13a of the conductive layers 12 and 13 are retreated from the opening part of the through hole 15a. However, inventors of the present invention consider that the effect of improving the gain by applying a higher voltage by suppressing discharge is actually larger than reduction of the gain in the through hole 15 by retreating the end portion. Based on this concept, the inventors of the present invention achieve the above-described structure.

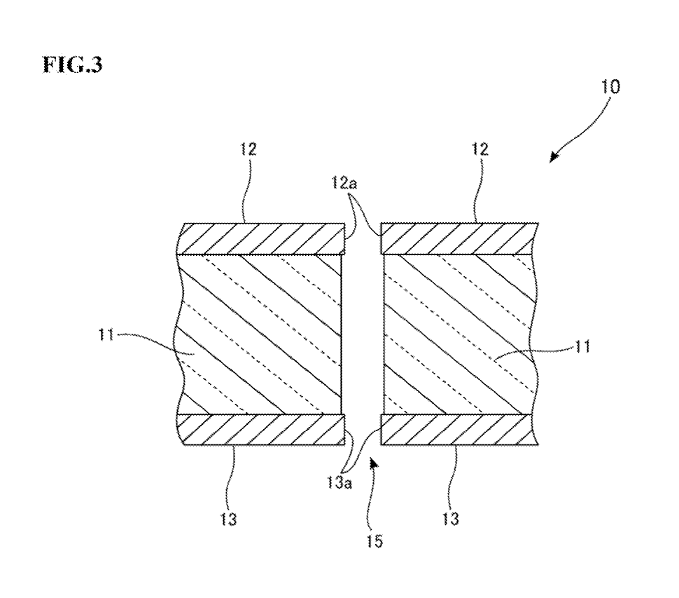

As shown by dot line in FIG. 2(b), the end portions of the conductive layers 12 and 13 are flush with the opening part of the through hole. However, as shown in FIG. 3, the end portion of the conductive layer is sometimes more protruded to a center side of the through hole than the opening part of the through hole in actual electronic amplifying substrate, due to a variation or dimensional tolerance at the time of manufacture, depending on the formation means of the through hole. In such a case, the end portions of the conductive layers are opposed to each other, thus easily allowing discharge to occur. Accordingly, by employing the above-described structure, a greater effect can be obtained.

A retreat distance of the end portions 12a and 13a of the conductive layers 12 and 13 may be determined in consideration of the reduction of the gain in the through hole due to retreat of the end, and improvement of the gain by suppressing the discharge. However, the effect of suppressing the discharge due to retreat of the end portion is great, and therefore the retreat distance is preferably small, and is preferably set to 30 μm or less in this embodiment. Further, the retreat distance of the end portion also depends on precision, etc., of the fine processing technique. In this embodiment, for example, when the diameter of the through hole 15 is 170 to 185 μm, and an arrangement pitch of the through hole is 280 μm, the retreat distance is about 10 μm.

In FIG. 2(a) and FIG. 2(b), the through hole 15a formed on the glass base material 11 is surrounded by the circumferential edge part (insulation part 20) of the through hole 15b formed on the conductive layers 12 and 13, in a ring shape. Namely, although the insulation part is formed so that the retreat distance of the end portion is constant over the whole circumference of the through hole 15, the retreat distance is not required to be constant if it is formed so as to retreat from the opening part of the through hole. That is, the insulation part may be formed so that the retreat distance is varied. Further, the retreat distance of the end portion in the conductive layer 12, and the retreat distance of the end portion in the conductive layer 13 may be different from each other.

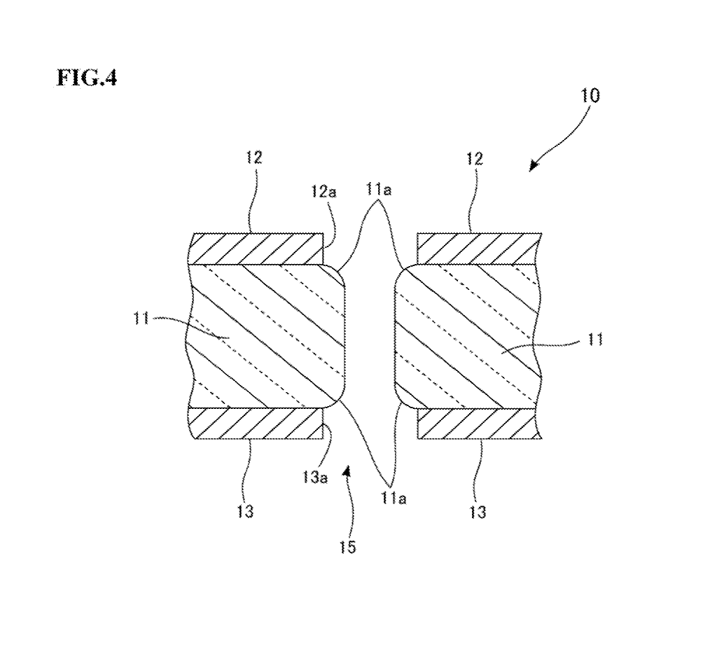

In this embodiment, as shown in FIG. 4, chamfering is preferably applied to a corner portion 11a of the opening part of the through hole 15b of the glass base material 11. Since the glass base material has insulation property, the electrons amplified in the through hole are sometimes charged-up on the glass base material. Charge-up is likely to occur at a sensitive part such as ridges, and therefore the corner portion is preferably chamfered. The shape of the chamfering is not particularly limited, and the shape capable of suppressing the charge-up may be selected. For example, the corner portion may be a planar shape or may be a rounded shape.

Further, since “PEG3” which is the photosensitive glass, has a volume resistivity of about 8.5×10¹² Ωm or more, charge-up is difficult due to low insulation resistance, compared with polyimide, etc., having a volume resistivity of 10¹⁵ Ωm or more. Therefore, the charge-up is further suppressed by performing chamfering. By performing chamfering, it is conceivable to generate discharge between the conductive layers 12 and 13, and therefore a chamfering amount is preferably set in consideration of this point.

### 3. Method of Manufacturing an Electronic Amplifying Substrate

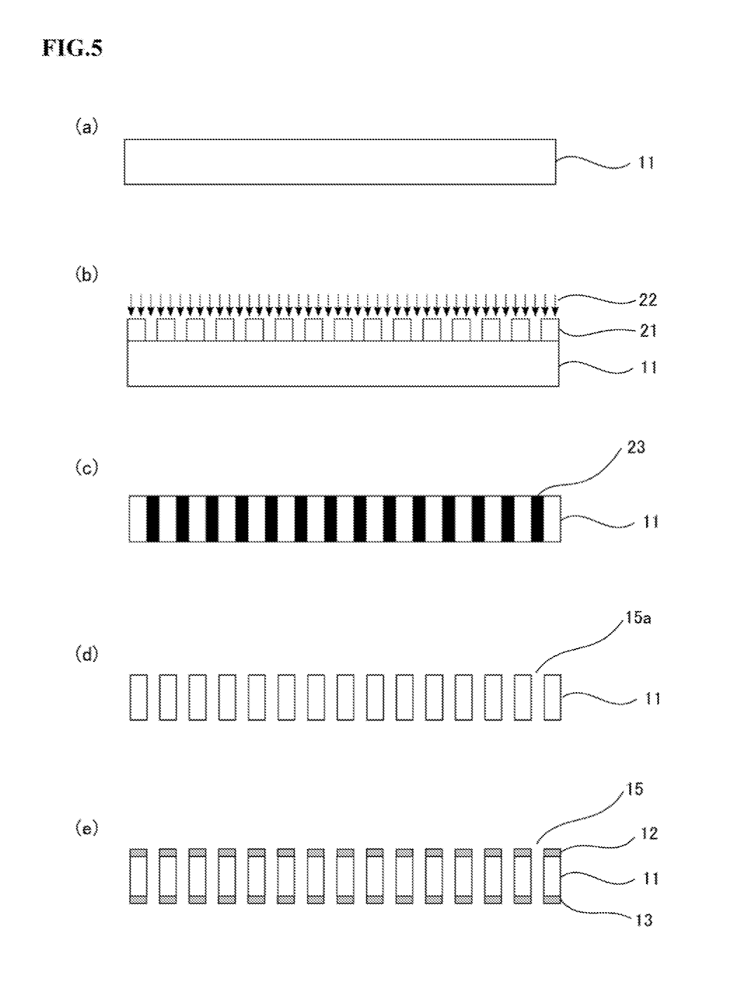

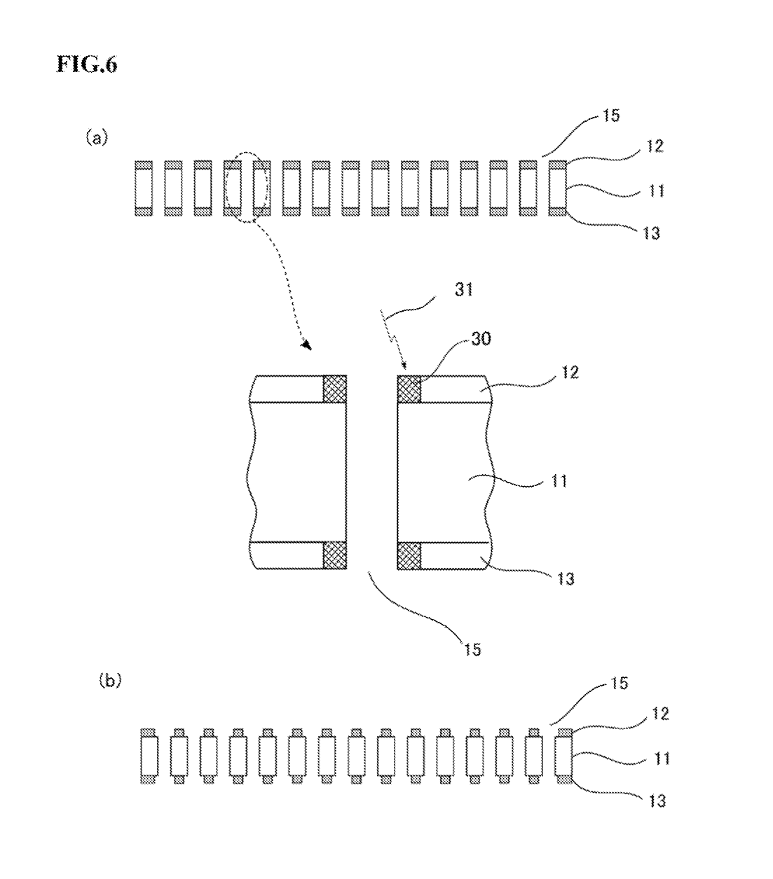

A method of manufacturing an electronic amplifying substrate 10 of this embodiment will be described next, using FIG. 5 and FIG. 6.

In this embodiment, first, as shown in FIG. 5(a), a flat plate-shaped glass base material 11 made of a photosensitive glass such as “PEG3” is prepared. The glass base material 11 has a desired dimension, and for example, has an outer shape formed into a rectangular shape of 300 mm×300 mm, with a thickness of about 0.3 mm to 1 mm.

Then, as shown in FIG. 5(b), a photomask 21 having a desired pattern formed thereon is superimposed on the prepared glass base material 11, and the glass base material 11 is irradiated with UV-ray 22 through the photomask 21. Thus, in the glass base material 11, an oxidation reduction reaction occurs between a photosensitive component and a sensitizer, at a place irradiated with UV-ray, and metal atoms are generated.

Subsequently, heat treatment is applied to the glass base material 11 after irradiation of the UV-ray, at a temperature of 450 to 600° C. for example. Then, as shown in FIG. 5(c), in the glass base material 11, the metal atoms generated by irradiation of the UV-ray are aggregated to form a colloid, and a crystal portion 23 of Li₂O.SiO₂ (lithium metasilicate) is precipitated and grown, with the colloid as a crystal nuclei.

As described above, Li₂O.SiO₂ (lithium metasilicate) precipitated here is easily dissolved in HF (hydrogen fluoride), and therefore as shown in FIG. 5(b), etching is applied to the glass base material 11 using HF. Thus, etching of removing the crystal portion 23 precipitated by heat treatment, namely selective etching utilizing a difference of a dissolving rate can be performed. As a result, a fine through hole 15 (for example, having a hole diameter of about φ30 μm to 170 μnm at arrangement pitch of about 50 μm to 340 μm) can be formed on the glass base material 11, with approximately the same precision as the pattern of the photomask 21 without using the mechanical processing.

Next, as shown in FIG. 5(e), conductive layers 12 and 13 are formed on both main surfaces of the glass base material 11 having the through holes formed thereon. In this embodiment, the conductive layer of a two-layer structure of a chromium (Cr) layer and a copper (Cu) layer is formed.

The method of forming the conductive layer is not particularly limited, and a sputtering method and a plating method, etc., may be used. In this embodiment, first, a chromium layer is formed on the surface of the glass base material having the through holes formed thereon by sputtering, and a copper layer is formed thereon. The thickness of the conductive layer is set to about 2 μm.

Thereafter, the end portions of the conductive layers 12 and 13 of the glass base material 11 are retreated from the opening part of the through hole 15 of the glass base material 11. The method of retreating the end portion of the conductive layer is not particularly limited, and for example, there is a method of removing a part of the conductive layer using laser beams, or a method of removing a part of the conductive layer by etching by use of a resist film or a mask. In this embodiment, the end portion of the conductive layer is retreated by processing using a laser beams.

Specifically, as shown in FIG. 6(a), the circumferential edge part of the through hole 15 which is a removal scheduled portion 30 of the conductive layers 12 and 13 is irradiated with a laser beam 31 having a prescribed energy, to thereby increase the diameter of the through hole 15b formed on the conductive layers 12 and 13 portions. Namely, laser beam scanning using the laser beam 31 is performed so that a hole is formed on the conductive layer, the hole having a larger diameter than the diameter of the through hole 15a formed on the glass base material 11 (for example, 40 μm larger diameter than the diameter of the through hole 15a). After scanning, the removal scheduled portion 30 of the conductive layer (chromium layer and copper layer) irradiated with laser beam 31 is evaporated, and the end portions 12a and 13a of the conductive layers 12 and 13 are retreated from the opening part, and the insulation part 20 is formed. Namely, the electronic amplifying substrate having the structure as shown in FIG. 6(b) can be obtained.

UV laser or femtosecond laser is preferable as the laser beam. Output of the laser beam may be determined in consideration of the retreat amount of the end portion, composition of the conductive layer to be removed, and the thickness, etc.

The end portion of the conductive layer can be efficiently and accurately retreated by the processing using the laser beam.

Copper plating, etc., may be performed to the conductive layer after processing of retreating the end portion of the conductive layer is performed. By performing such plating, the end portion of the conductive layer is advanced (the conductive layer is formed toward the center side of the through hole). However, since the maximum advancement amount is about 1 μm, the abovementioned effect can be sufficiently obtained by setting the retreat amount in consideration of the advancement amount by plating.

The corner portion of the through hole 15a formed on the glass base material 11 is exposed after retreat of the end portions 12a and 13a of the conductive layers 12 and 13. In this case, chamfering is performed to the corner portion 11a of the through hole 15a formed on the glass base material 11, as needed. Although the method of chamfering is not particularly limited, in this embodiment, chamfering is performed by etching. Specifically, chamfering is performed using an etchant with more increased activity than an etchant used for forming the through hole 15 on the glass base material 11. When etching is applied to the glass base material 11 using such an etchant, the corner portion 11a which is the glass portion is partially removed and chamfered, due to high activity of the etchant. The method of increasing the activity of the etchant is not particularly limited, and for example, a temperature of the etchant may be raised, or a liquid property of the etchant may be changed, or the like.

### 4. Measurement Procedure of the Ionized Electrons in the Detector

Next, when a detector 1 is constituted using the electronic amplifying substrate 10 of this embodiment, explanation is specifically given hereafter for a procedure of measuring the ionized electrons and detecting a particle beam or an electromagnetic wave by this detector 1, with reference to FIG. 1. Wherein, for example, X-ray is an object to be detected, and explanation will be given as follows.

The chamber 2 of the detector 1 is filled with a prescribed kind of detection gas. Further, in order to draw the electrons generated in the drift region 5 toward the read electrode 4, a magnitude of the voltage is applied to each of the drift electrode 3, the read electrode 4, and the conductive layers 12 and 13 of the electronic amplifying substrate 10 respectively, to thereby generate electric fields E1, E2, and E3. Namely, in order to give a potential difference so that an electron drawing force becomes larger toward the read electrode 4, the voltage is applied to the drift electrode 3, the read electrode 4, and the conductive layers 12 and 13 of the electronic amplifying substrate 10 respectively.

Specifically, for example, the chamber 2 is filled with a mixed gas of Ar 70% and CH₄ 30% as a detection gas at a pressure of 1 atm. Further, for example, the magnitude of the application voltage to the drift electrode 3, the read electrode 4, and the electronic amplifying substrate 10 and each positional relation (size of an interval) are suitably set so that electric field E1 of the drift region 5 is about 125 to 500 V/cm, and electric filed E3 of the induction region 6 is 2.5 to 5 kV/cm. Further, for example, the application voltage to the conductive layers 12 and 13 of the electronic amplifying substrate 10 is also suitably set so that a sufficient electric field E2 can be formed for causing the electron avalanche amplification in the through hole 15.

When for example the X-ray emitted from a source of 55Fe is incident on the chamber 2, the gas in the drift region 5 is ionized by the incident X-ray, and by this ionization action, electrons are generated. At this time, electric field E1 is formed in the drift region 5, and therefore generated electrons are drawn to the electronic amplifying substrate 10, and are ready to pass through the through hole 15 of the electronic amplifying substrate 10.

However, a high electric field is generated in the through hole 15 by formation of the electric field E2. Therefore, a speed of the electrons that pass through the through hole 15 is accelerated by a high electric field, thus increasing a kinetic energy, and giving energy to other surrounding electrons, to thereby discharge electrons by a new ionization action. By repeating this process, the electrons are amplified, resulting in avalanche amplification. Namely, when the electrons pass through the through hole 15, the electron avalanche amplification occurs.

The electrons amplified by the electron avalanche amplification are drawn to the read electrode 4 by the electric field E3 formed in the induction region 6. Then, the number of electrons is read as a signal, by the read electrode 4. The read electrode 4 that performs signal reading as described above, is divided into small areas. Therefore, which area is selected to measure the electrons can be specified.

Through the above-described procedure, the detector 1 can detect the X-ray to be detected.

### 5. Effect of this Embodiment

In this embodiment, the end portions 12a and 13a of the conductive layers 12 and 13 are retreated from the opening part of the through hole 15a of the glass base material 11. In other words, the diameter of the through hole 15b formed on the conductive layers 12 and 13 is formed larger than the diameter of the through hole 15a formed on the glass base material 11. This means that the opening part of the through hole 15a of the glass base material 11 is surrounded by the insulation part 20. Therefore, the distance between the conductive layers 12 and 13 formed on both main surfaces of the glass base material 11, namely, in the through hole 15, the distance (discharge distance) between the end portions of the conductive layers is prolonged, and in addition, a circumferential portion of the hole where the electric force lines are concentrated can be kept away from the hole, and therefore the discharge can be effectively suppressed. Further, such an effect can be obtained by the abovementioned simple structure.

Since the end portions 12a and 13a of the conductive layers 12 and 13 are retreated, there is a possibility that the number of the electric force lines passing through the through hole 15 is decreased. However, by suppressing the discharge, an application voltage can be high, and as a result, the amplification factor can be improved. Specifically, the amplification factor of 10⁴ or more and preferably about 10⁵ can be obtained.

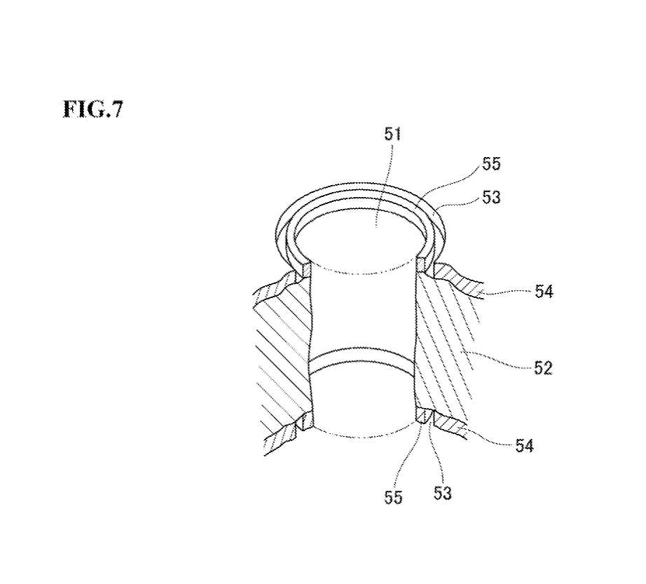

Further, when the structure shown in FIG. 7 is compared with the electronic amplifying substrate, the application voltage is not reduced even in the vicinity of the end portion of the conductive layer. Therefore, a strong electric field can be formed in the through hole. Accordingly, a sufficient amplification factor can be secured.

Further, in this embodiment, the corner portion 11a of the through hole 15a of the glass base material 11 is chamfered. Namely, the corner portion 11a of the through hole 15a does not have a sharp shape, and therefore the electrons generated in the through hole 15 are hardly charged-up to the glass base material 11 having the insulating property. Accordingly, the electrons generated in the through hole 15 can reach the read electrode 4 without being adsorbed on the glass base material.

Further, in this embodiment, the electronic amplifying substrate 10 having the above-mentioned structure, is manufactured by processing using a laser beam. By evaporating a part of the conductive layers 12 and 13 by irradiation of the laser beam, the end portions 12a and 13a of the conductive layers 12 and 13 are retreated from the opening part of the through hole 15 of the glass base material 11. By employing a processing technique using the laser beam, the end portion of the conductive layer can be easily and efficiently retreated with high precision.

Such an effect cannot be obtained when using the resin material such as polyimide as the base material of the electronic amplifying substrate. If the processing technique of using the laser beam is attempted to apply to the resin material, the resin material itself is sometimes evaporated by an irradiation energy of the laser beam. Even if the processing technique using the laser beam can be applied to the resin material, it is extremely difficult to appropriately position an irradiation position of the laser beam, due to deformation, etc., of the resin material even by fixing the resin material during processing, thus making it impossible to avoid a large error in the irradiation position. Therefore, probably, processing cannot be performed so as to satisfy the precision of the diameter of the through hole and an arrangement pitch required for the electronic amplifying substrate. For example, when the end portion of the conductive layer is attempted to be retreated by the processing using the laser beam applied to the base material made of polyimide, it can be considered as follows: for example, a retreat distance of the end portion of the conductive layer exceeds 150 nm, and the arrangement pitch exceeds 400 nm.

### 6. Modified Example, Etc.

In the above-described embodiment, the end portions of the conductive layers 12 and 13 formed on both main surfaces of the electronic amplifying substrate 10, are retreated. However, it is also acceptable to retreat only one end portion of one of the conductive layers. Even with this structure, the effect of suppressing the discharge as described above, can be obtained. However, there is a possibility that a risk of discharge is increased, compared with the abovementioned embodiment.

In the case of the abovementioned structure, the end portion of the conductive layer 12 is retreated, namely the end portion of the conductive layer positioned at an entrance side (drift electrode 3 side) of the electrons, is retreated, and the end portion of the conductive layer 13 is retreated, namely the end portion of the conductive layer positioned at an exist side of the electrons (read electrode 4 side), is retreated. By employing this structure, in addition to the effect of suppressing the discharge, the number of the electrons measured by the read electrode 4 can be increased without allowing the electrons to be spread in a horizontal direction, when the electrons amplified in the through hole 15 pop out from the through hole 15. As a result, precision of detecting the particle beam or the electromagnetic wave to be detected, can be improved. Accordingly, this structure is preferable when improvement of the detection precision is more emphasized than suppression of the discharge.

In the above-described embodiment, the photosensitive glass is used as the glass base material. However, a crystallized glass obtained by crystallizing the photosensitive glass may be used for example.

Further, in the above-described embodiment, a part of the conductive layer is removed by the processing technique of using the laser beam. However, a part of the conductive layer may be removed by etching using a resist film or a mask. Specifically, the resist film is formed on the substrate before/after the through hole 15a is formed on the glass base material 11, or a portion supposed to be an insulating portion surrounding the opening part of the through hole 15a, is exposed, with a mask superposed thereon, and thereafter this portion may be removed by wet etching, etc.

Further, the above-described embodiment shows a case that there is only one electronic amplifying substrate 10 in the chamber 2 for example. However, a plurality of electronic amplifying substrates 10 may be provided in the chamber 2. In the detector 1 with a structure that a plurality of electronic amplifying substrates 10 are provided, an apparatus structure is complicated, compared with a case that there is only one electronic amplifying substrate 10. However, it becomes easy to increase the gain during the electron avalanche amplification.

Further, the above-described embodiment shows a case that the through hole 15 on the electronic amplifying substrate 10 is a round hole for example. However, when the electric field is formed in the hole, the through hole 15 is not required to be a round hole, but may have other shape such as a square hole, etc.

Further, the above-described embodiment shows a case that the read electrode 4, etc., in the chamber 2 constituting the detector 1, is formed into a flat plate shape. However, the read electrode 4, etc., may be formed in a straight line shape called a micro strip for example.

The embodiments of the present invention have been described above. However, the present invention is not limited to the abovementioned embodiments, and can be variously modified in a range not departing from the gist of the present invention.

### EXAMPLE

The present invention will be described hereafter based on further detailed examples. However, the present invention is not limited to these examples.

### Example 1

PEG3 by HOYA Corporation was used as the glass base material. The PEG3 was a photosensitive glass, and had a composition of SiO₂—Li₂O—Al₂O₃. Further, a thickness of the PEG3 was 0.7 mm.

Exposure was performed to the glass base material by UV-ray, using a mask having a pattern for forming the through hole having a diameter of 50 μm at an arrangement pitch of 150 μm, to thereby precipitate a crystal on a portion irradiated with the UV-ray, and further heat treatment was applied thereto at 600° C., and subsequently etching was performed thereto using hydrogen fluoride (HF) so that the portion irradiated with the UV-ray was removed, to thereby form the through hole having a diameter of 50 μm.

A chromium thin film was formed on the glass base material by sputtering applied to the glass base material with the through hole formed thereon, and a conductive layer was constituted by forming a copper thin film thereon. The thickness of the conductive layer was 2 μm.

Processing of retreating the end portions of both conductive layers, was performed to both main surfaces of the glass base material having conductive layers formed thereon, using UV-laser (having a wavelength of 355 nm). A retreat distance was 20 μm.

On the obtained electronic amplifying substrate, the through hole having a diameter of 50 μm was formed at an arrangement pitch of 150 μm, and the end portion of the conductive layer was retreated by 20 μm from the opening part of the through hole. The detector was constituted using the electronic amplifying substrate, and X-ray of ⁵⁵Fe was detected in an atmosphere of flowing gases such as Ar 70% and CH₄ 30%. As a result, even when the application voltage was set to 3000V, discharge between the conductive layers didn't occur. When using the substrate in which the end portion of the conductive layer was not retreated, the discharge occurred at an application voltage of 2200V.

### Example 2

PEG3 similar to the PEG3 of example 1 was used as the glass base material. Exposure was performed to the glass base material by UV-ray, using the mask having the pattern for forming the through hole having a diameter of 50 μm at an arrangement pitch of 150 μm, to thereby precipitate a crystal on a portion irradiated with the UV-ray, and further heat treatment was applied thereto at 600° C. Subsequently, a chromium thin film was formed on the glass base material by sputtering, and a copper thin film was formed thereon, to thereby constitute the conductive layer. A thickness of the conductive layer was 2 μm.

Next, a resist film was formed on the conductive layer, and laser exposure development was performed thereto. At this time, exposure was performed to a portion having a diameter larger by 40 μm than the diameter of the formed through hole.

After exposure, etching was performed using iron chloride (FeCl₃), to thereby remove the conductive layer. Namely, a hole having a diameter of 90 μm was formed on the conductive layer at an arrangement pitch of 150 μm.

Etching was performed to the glass base material which was exposed by etching applied to the conductive layer so that a portion irradiated with UV-ray was removed, to thereby form the through hole. The through hole having a diameter of 50 μm was formed on the obtained electronic amplifying substrate at an arrangement pitch of 150 μm, and the end portion of the conductive layer was retreated by 20 μm from the opening part of the through hole. A detector was constituted using this electronic amplifying substrate, to thereby detect the X-ray. As a result, discharge between the conductive layers didn't occur even if the application voltage was set to 3000V.

### Example 3

Etching was further applied to the electronic amplifying substrate obtained in example 2, using hydrogen fluoride (HF) at 60° C., so that the corner portion of the opening part of the through hole was rounded. The detector was constituted using the obtained electronic amplifying substrate, to thereby detect the X-ray. As a result, it was confirmed that the discharge between the conductive layers didn't occur, and the charge-up in the through hole was suppressed, even if the application voltage was set to 3000V.

### DESCRIPTION OF SIGNS AND NUMERALS

1 Detector
2 Chamber
3 Drift electrode
4 Read electrode
10 Electronic amplifying substrate
14 Lamination body
11 Glass base material
12, 13 Conductive layer
15 Through hole

1. An electronic amplifying substrate, comprising:
a glass base material having an insulating property;
conductive layers formed on both main surfaces of the glass base material; and
a plurality of through holes formed on a lamination body of the glass base material and the conductive layer,
wherein an electric field is formed in the through hole by a potential difference between both conductive layers during application of a voltage to a surface of the conductive layer so that an electron avalanche amplification occurs in the through hole, and
an insulation part is formed on at least one main surface of the glass base material, with one of the end portions of the insulation part formed to surround an opening part of the through hole of the glass base material, and the other end portion formed in contact with the end portions of the conductive layers.

2. The electronic amplifying substrate according to claim 1, wherein the end portion of the conductive layer on at least one main surface of the glass base material, is formed so as to retreat from the opening part of the through hole of the glass base material.

3. The electronic amplifying substrate according to claim 2, which is disposed between a drift electrode and a read electrode constituting a detector,
wherein the end portion of the conductive layer formed on a main surface opposed to the read electrode, is retreated from the opening part of the through hole of the glass base material.

4. The electronic amplifying substrate according to claim 2, which is disposed between the drift electrode and the read electrode constituting the detector,
wherein in a cross-sectional surface of the electronic amplifying substrate, the end portions of the conductive layer formed on both of the main surfaces are retreated from the opening part of the through hole of the glass base material.

5. The electronic amplifying substrate according to claim 1, wherein a corner portion of the through hole formed on the glass base material is chamfered.

6. The electronic amplifying substrate according to claim 1, wherein the end portion of the conductive layer is retreated from the opening part of the through hole of the glass base material, by processing using a laser beam.

7. The electronic amplifying substrate according to claim 1, wherein the glass base material is constituted of a photosensitive glass.

8. A method of manufacturing an electronic amplifying substrate comprising:
a glass base material having an insulating property;
conductive layers formed on both main surfaces of the glass base material; and
a plurality of through holes formed on a lamination body of the glass base material and the conductive layer,
wherein an electron avalanche amplification occurs in the through hole by forming an electric field in the through hole by a potential difference between both conductive layers when a voltage is applied to a surface of the conductive layer,
the method comprising:
making an end portion of the conductive layer formed on at least one main surface of the glass base material retreat from an opening part of the through hole of the glass base material, by applying processing to the formed conductive layers using a laser beam.
